(19) United States
(12) Patent Application Publication
(10) Pub. No.: US 2010/0088249 A1
(43) Pub. Date: Apr. 8, 2010

(54) Trade Risk Management

(76) Inventors: Ashok H. Mittal, Tinton Falls, NJ (US); Vinayck K. Singh, Litchfield, CT (US)

Correspondence Address: Ashok Tankha, 36 Greenleigh Drive, Sewell, NJ, 08080, US

(21) Appl. No.: 12/247,392

(22) Filed: Oct. 8, 2008

(51) Int. Cl. G06Q 40/00

(52) U.S. Cl. 705/36 R

(57) ABSTRACT

Disclosed herein is a computer implemented method and system for managing financial risk involved in trading of multiple financial instruments between multiple counterparties. A risk profile is determined for each of the counterparties based on transaction data provided by the counterparties. The transaction data relates to trading of the financial instruments. Individual prices for multiple predefined maturity periods of the financial instruments are provided by the counterparties based on the risk profile. A consensus price is created for each of the predefined maturity periods based on the individual prices. The created consensus price is compared with each of the individual prices provided by each of the counterparties. The financial risk is computed for each of the counterparties based on multiple predefined parameters and the comparison. The computed financial risk of each of the counterparties is modified by each of the counterparties for the management of the financial risk.

### BACKGROUND

This invention, in general, relates to risk management. More particularly, this invention relates to a system for creating deep pools of liquidity across the maturity ladder of financial instruments for identifying switch trades between counterparties with naturally offsetting positions, enabling participants to reduce default and curve volatility risk in bulk, efficiently and cost effectively.

In recent years, growth of trading volumes of credit derivates swaps (CDS) among dealers has resulted in an accumulation of date mismatches within housed portfolios across the maturity spectrum. As positions roll-off over time, jump to default (JTD) risk accumulates in areas of the curve with minimal liquidity. The accumulation of market risk in illiquid maturities may leave portfolios highly exposed to credit events and adverse changes in the shape of the credit curve. Moreover, mitigation through traditional transactions in the inter-dealer market is rendered difficult.

Hence, there is a need for a computer implemented method and system that provides deep pools of liquidity for financial instruments, thereby enabling investors to reduce trade risk and provide a solution for managing risk profiles and reducing exposure that may have taken investors many years to accumulate.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for providing deep pools of liquidity for financial instruments, thereby enabling investors to reduce trade risk and provide a solution for managing risk profiles and reducing exposure that may have taken investors many years to accumulate. The computer implemented method and system manages the financial risk involved in trading of multiple financial instruments between multiple counterparties The counterparties provide transaction data relating to trading of the financial instruments. The transaction data is normalized to a predefined format.

A risk profile is determined for each of the counterparties based on the normalized transaction data. Individual prices for multiple predefined maturity periods of the financial instruments are provided by the counterparties based on the risk profile. A consensus price is created for each of the predefined maturity periods based on the individual prices. As used herein, the term “consensus price” refers to a price determined by performing a predefined set of computations on the individual prices. The consensus price may be created using curve pricing. Curve pricing is the pricing provided by each of the counterparties for each of the maturity periods of their financial instruments that they seek to sell or purchase.

The created consensus price is compared with each of the individual prices provided by each of the counterparties. The financial risk is computed for each of the counterparties based on multiple predefined parameters and the comparison. The predefined parameters may, for example, be one or more of entity, maturity dates, minimum amount, and a maximum distance between two switches in a switch trade. The computed financial risk of each of the counterparties is modified by each of the counterparties for the management of the financial risk. The step of modifying the computed financial risk may comprise increasing or decreasing the financial risk for a trade to be performed. Trade reports may be generated for the counterparties. The trade reports comprise details of the trading. An order for a trade may be received from the counterparties. The trade may then be performed between the counterparties.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of managing financial risk involved in trading of financial instruments between multiple counterparties.

FIG. 2 illustrates a computer implemented system for managing financial risk involved in trading of financial instruments between multiple counterparties.

FIGS. 3A-3L exemplarily illustrate the process involved in managing financial risk involved in trading of financial instruments between multiple counterparties.

### DETAILED DESCRIPTION OF THE INVENTION

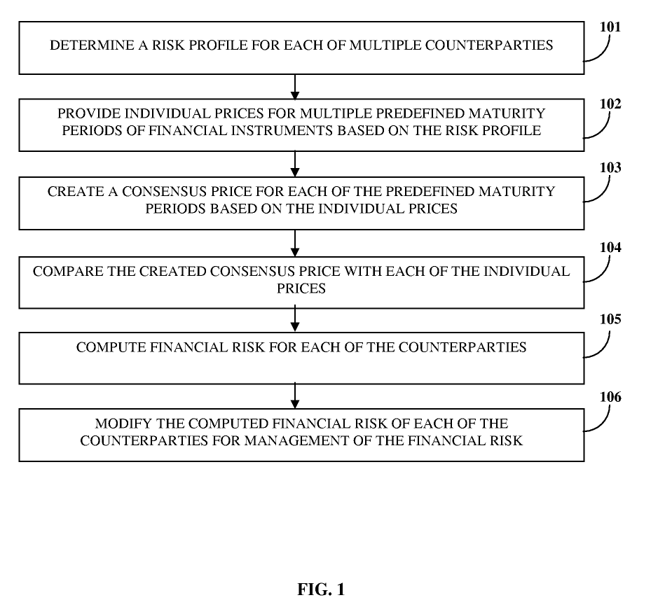

FIG. 1 illustrates a computer implemented method of managing financial risk involved in trading of financial instruments between multiple counterparties. One of the financial instruments may, for example, be a credit default swap (CDS). The CDS is a bilateral agreement between the counterparties to trade credit risk of at least one third counterparty. The counterparties may, for example, be one or more of sellers and buyers of the CDS. The other financial instruments may, for example, be interest rate derivatives, foreign exchange (FX) derivatives, equity derivatives, energy, environmental and catastrophe derivatives, etc.

The counterparties provide transaction data relating to trading of the financial instruments. The transaction data may, for example, be past transaction records, trade prices, etc. The transaction data provided by the different counterparties may be in different formats. The transaction data in the different formats is normalized to a predefined format. A risk profile is determined 101 for each of the counterparties based on the normalized transaction data. The counterparties provide 102 individual prices for multiple predefined maturity periods of the financial instruments based on the risk profile. Each of the counterparties may provide a unique individual price. The individual prices may be computed by each of the counterparties based on algorithms unique to the counterparties.

A consensus price is created 103 for each of the predefined maturity periods based on the individual prices. As used herein, the term “consensus price” refers to a price determined by performing a predefined set of computations on the individual prices. The consensus price may be created using curve pricing. Curve pricing is the pricing provided by each of the counterparties for each of the maturity periods of their financial instruments that they seek to sell or purchase. The consensus price depends upon the individual prices provided by each one of the counterparties. The consensus price is a price indicating a general pricing trend among the counterparties. The consensus price may, for example, be created by discarding the highest 20% of the individual prices and the lowest 20% of the individual prices. The remaining 60% of the individual prices may then be averaged. Spread differences between different predefined maturity periods are displayed to the counterparties. The spread prices are then averaged by once again discarding the highest 20% and the lowest 20% and averaging the remaining 60%. The averaged spread prices may be adjusted with manual intervention. Then, exemplarily, considering a maturity period of 5 years as an anchor point, prices are generated by applying the averaged spread prices to the 5 year price to obtain the consensus price.

The created consensus price is compared 104 with each of the individual prices provided by each of the counterparties. The counterparties are provided the created consensus price. The counterparties determine the status of their individual price with respect to the individual prices provided by the other counterparties and the created consensus price.

The financial risk is computed 105 for each of the counterparties based on multiple predefined parameters and the comparison. The predefined parameters may, for example, be one or more of entity, maturity dates, minimum amount, a maximum distance between two switches in a switch trade, profit and loss, total amount of risk reduced, etc. The computed financial risk for each of the counterparties represents degree of risk involved in trading with that counterparty. The degree of risk may not necessarily be indicative of the competency of the counterparties. For example, a counterparty providing a high return on an investment may have a greater associated financial risk. Many people may choose to trade with that counterparty because of the higher returns, rather than a second counterparty providing lower returns with a lower degree of risk.

The computed financial risk of each of the counterparties may be modified 106 by each of the counterparties for the management of the financial risk. The step of modifying the computed financial risk may comprise increasing or decreasing the financial risk for a trade to be performed. For example, the counterparties may increase the return on investment along with the associated financial risk. Trade reports may be generated for the counterparties. The trade reports comprise details of the trading. An order for a trade may be received from the counterparties. The orders are processed using a matching algorithm. The trade may be performed between the counterparties. The counterparties review the trade reports and evaluate their original risks, the amount of risks reduced, the amount of risk reduction they decided to forgo, etc. and then they submit the trades for execution. Mutually accepted trades with pre-approved counterparties are then confirmed by revealing the identity of the counterparties. The executed trades are then confirmed, for example, through straight through processing (STP). STP enables the entire trade process to be conducted electronically without the need for re-keying or manual intervention.

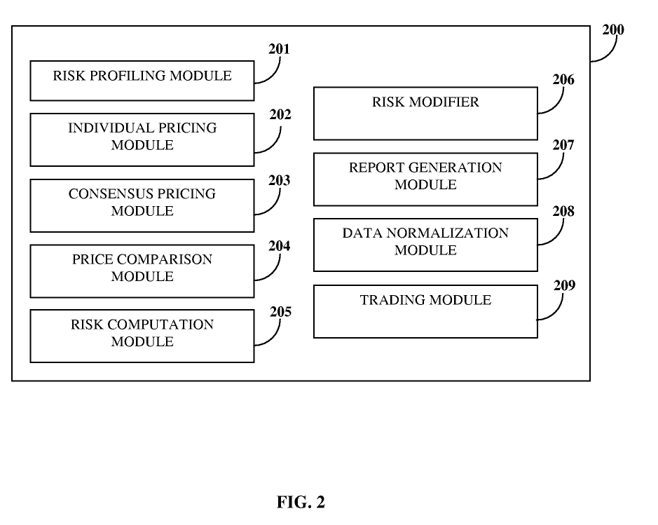

FIG. 2 illustrates a computer implemented system 200 for managing financial risk involved in trading of financial instruments between multiple counterparties. The system 200 disclosed herein comprises a risk profiling module 201, an individual pricing module 202, a consensus pricing module 203, a price comparison module 204, a risk computation module 205, a risk modifier 206, a report generation module 207, a data normalization module 208, and a trading module 209.

The risk profiling module 201 determines a risk profile for each of the counterparties based on transaction data provided by the counterparties. The transaction data relates to trading of the financial instruments. The data normalization module 208 normalizes the transaction data to a predefined format provided by the counterparties prior to the determination of the risk profile. The individual pricing module 202 provides individual prices for multiple predefined maturity periods of the financial instruments based on the risk profile. The consensus pricing module 203 creates a consensus price for each of the predefined maturity periods based on the individual prices. The price comparison module 204 compares the created consensus price with each of the individual prices provided by each of the counterparties. The risk computation module 205 computes the financial risk for each of the counterparties based on multiple predefined parameters and the comparison. The predefined parameters may, for example, be one or more of entity, maturity dates, minimum amount, and a maximum distance between two switches in a switch trade. The risk modifier 206 modifies the computed financial risk of each of the counterparties for the management of the financial risk.

The report generation module 207 generates trade reports for the counterparties. The trade reports comprise details of the trading. The trading module 209 receives an order for a trade from the counterparties and performs the trade between the counterparties.

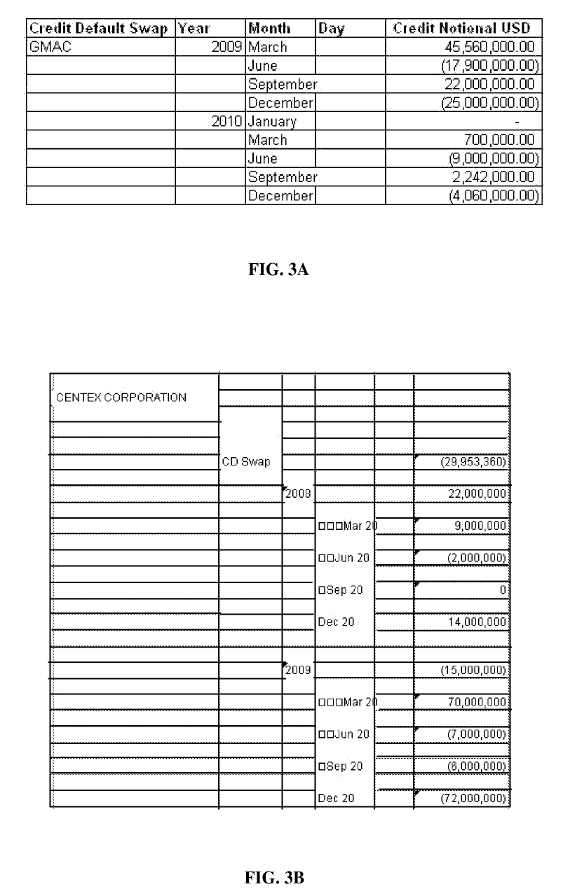

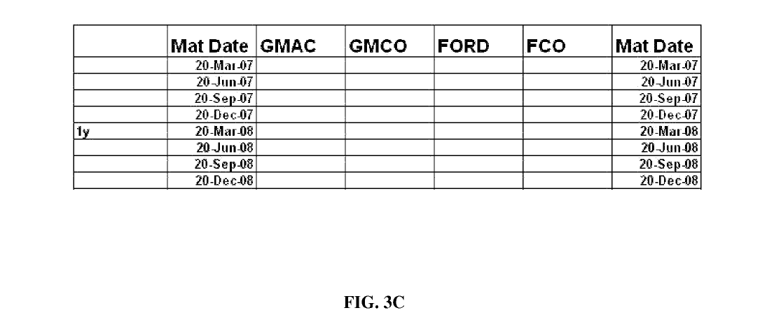

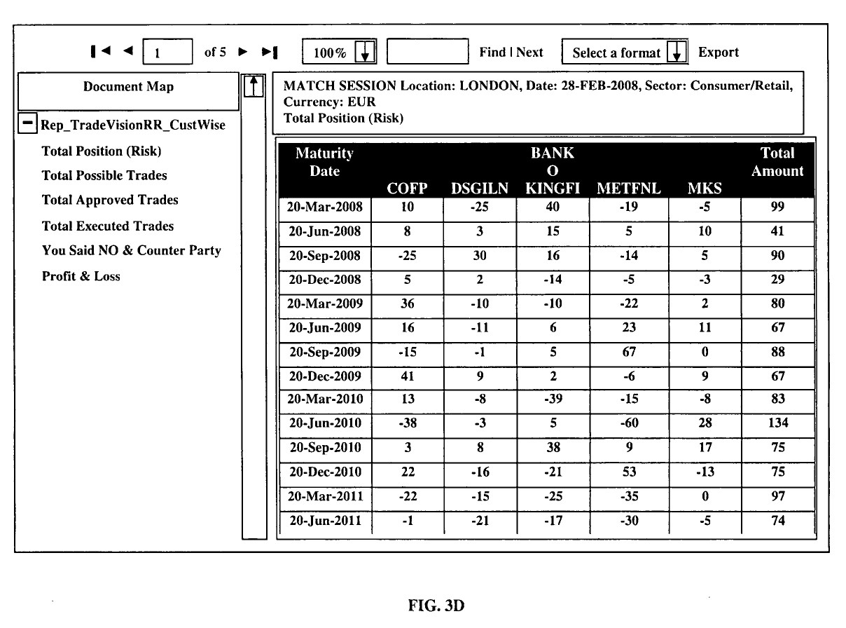

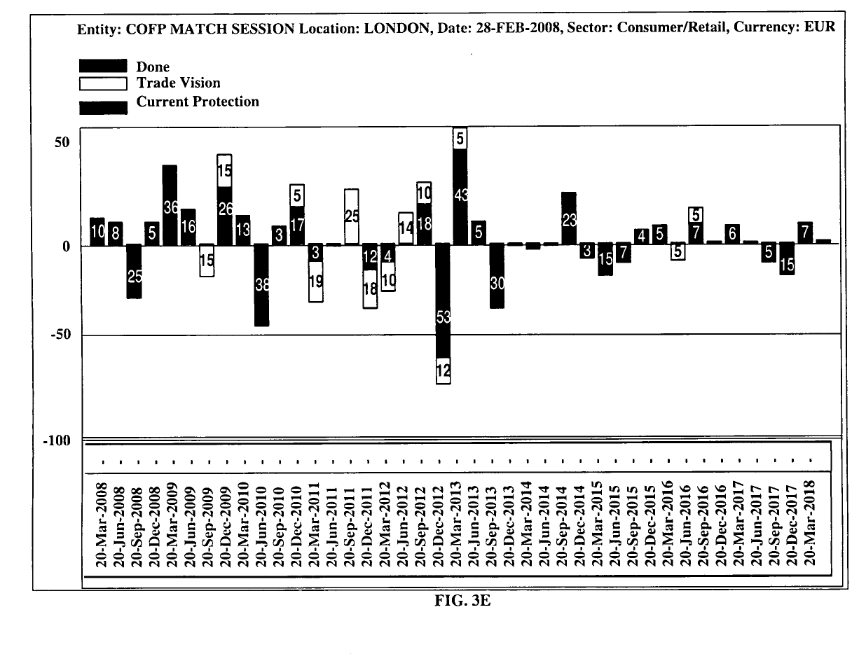

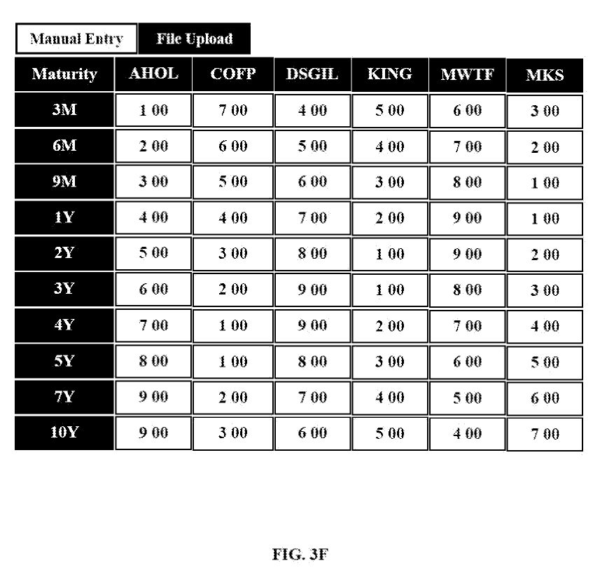

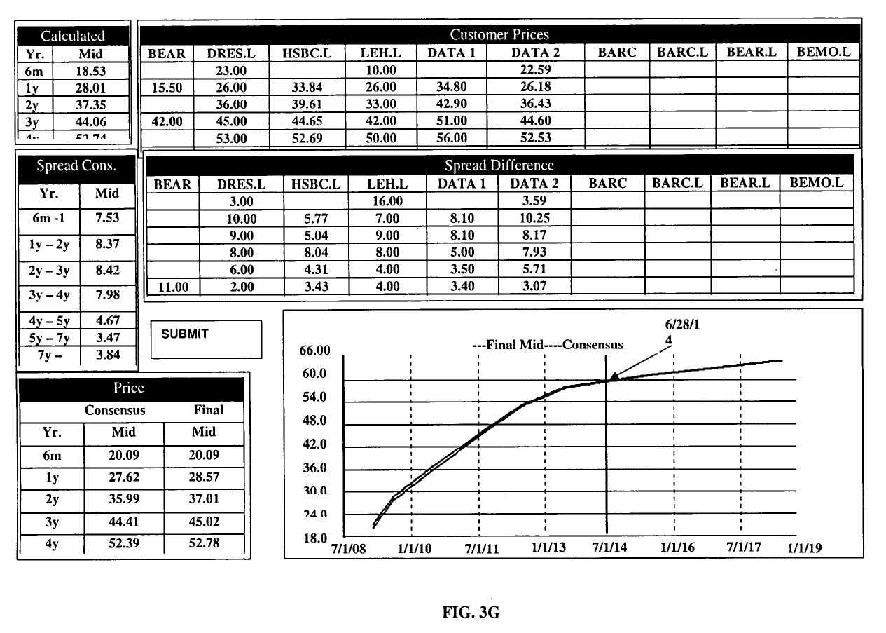

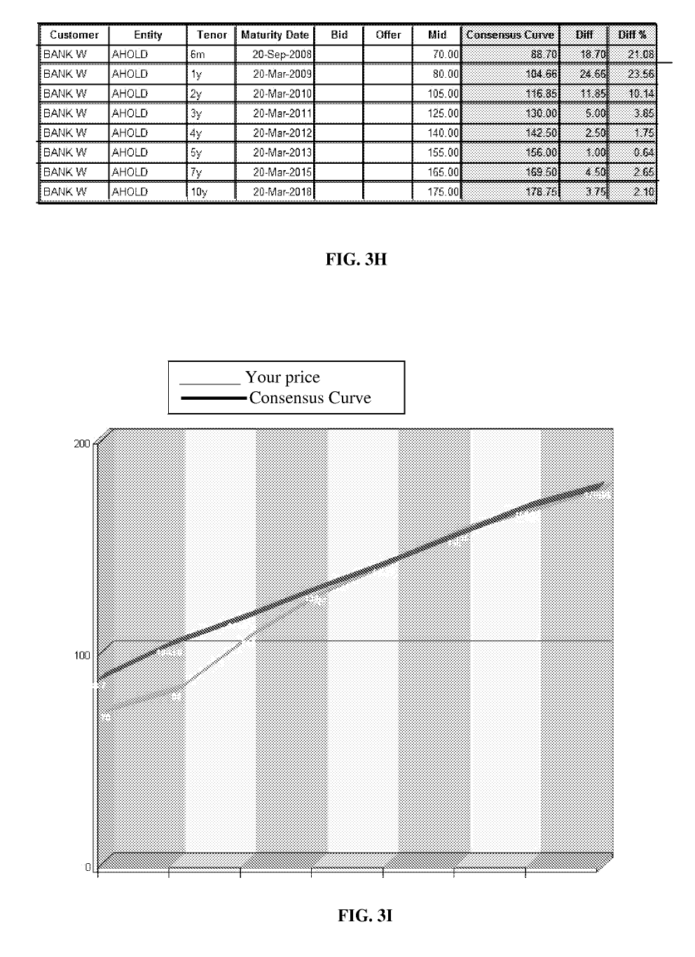

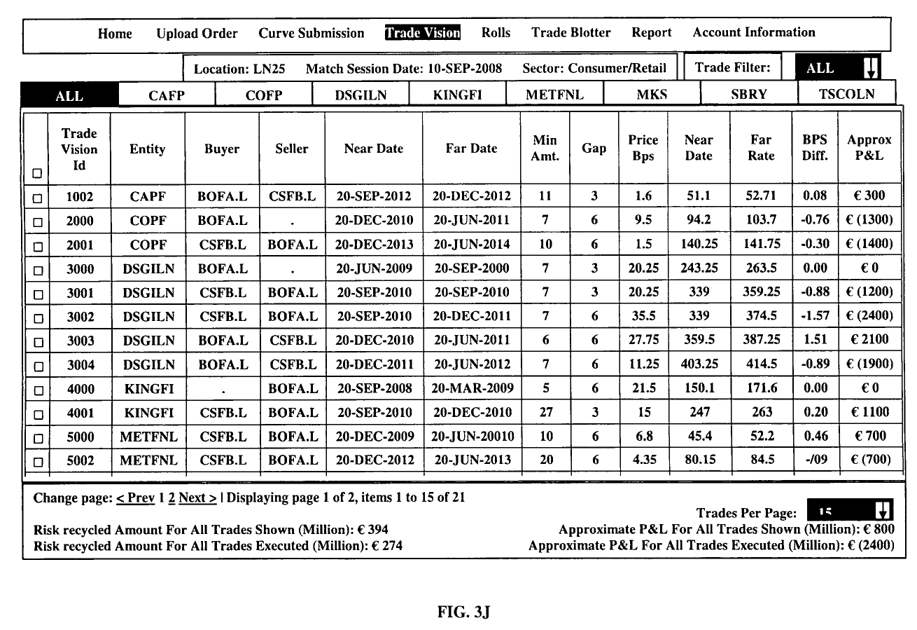

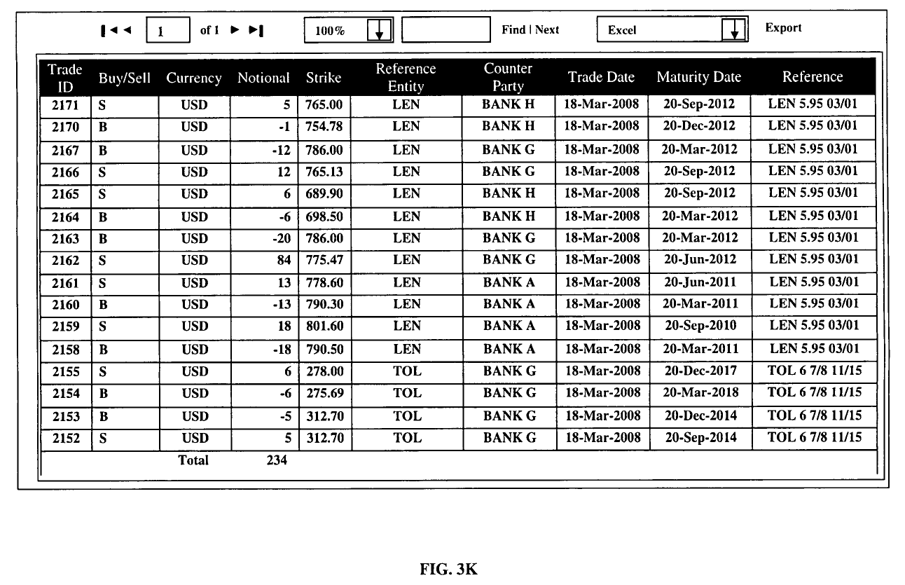

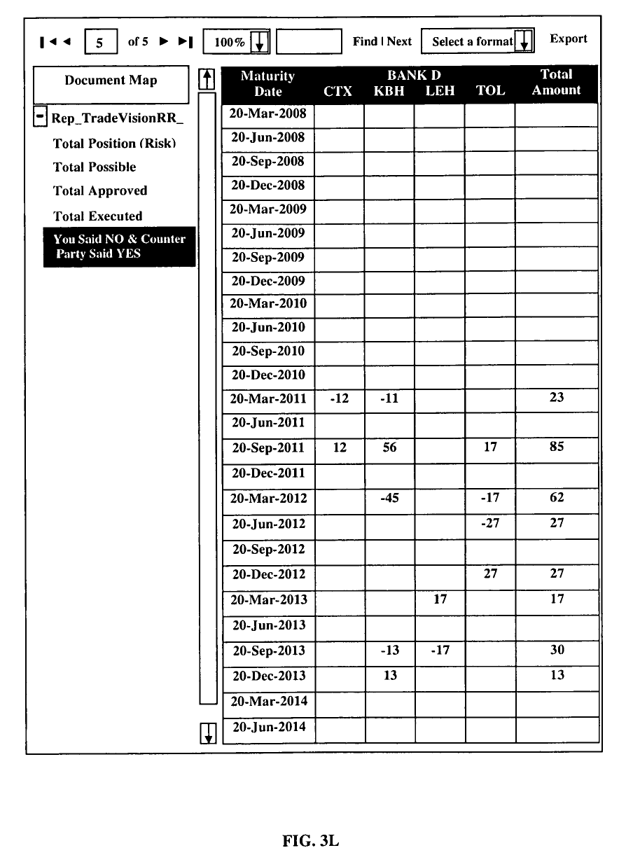

FIGS. 3A-3L exemplarily illustrate the process involved in managing financial risk involved in trading of financial instruments between multiple counterparties. The counterparties provide the transaction data. The transaction data may describe a credit default swaps (CDS) transacted by the counterparties. The counterparties may provide the transaction data as a transaction log for the financial instruments, as exemplarily illustrated in FIG. 3A. The counterparties may also provide the transaction data as a part of a risk report, as exemplarily illustrated in FIG. 3B. Further, the counterparties may provide the transaction data by filling in a provided template, as exemplarily illustrated in FIG. 3C.

The transaction data may reflect protection or risk of the counterparties. The protection may be reflected as bought or sold CDS by the counterparties. The risk may be reflected as exposure of the counterparties. The transaction data is processed through different filters. The processing may comprise one or more of presenting of the transaction data in terms of financial risk, ignoring transactions with maturity periods other than the predefined maturity periods, and ignoring transactions with currencies other than a predefined currency. The processing may also comprise ignoring transactions for which reference entities, for example, credit events, do not match with predefined reference entities. The processing may further comprise adding transactions for an entity for a particular maturity date for each one of the counterparties and rounding the sum to a nearest integer value.

A risk profile is determined for each of the counterparties and provided to the counterparties. The risk profile may be provided to the counterparties in a tabular format, as exemplarily illustrated in FIG. 3D. The risk profile may also be provided in a graphical format, as exemplarily illustrated in FIG. 3E. The risk profile enables the counterparties to visualize the financial risks over the entire maturity periods of the financial instruments.

The counterparties provide individual prices for multiple predefined maturity periods of the financial instruments, as exemplarily illustrated in FIG. 3F. For example, if a credit default swap (CDS) for an entity has a total of 40 quarterly maturity dates over 10 years, the counterparties may provide individual prices for CDS for the predefined maturity periods only, such as 6 months, 1 year, 2 year, 3 year, 4 year, 5 year, 7 year and 10 year.

A consensus price is created for each of the counterparties. The computation of the consensus price is exemplarily illustrated in FIG. 3G. A consensus curve is built based on the consensus price. The consensus price and the consensus curve are provided to the counterparties along with the individual prices provided by the counterparties and the difference between the individual prices and the consensus price, as exemplarily illustrated in FIGS. 3H-3I.

Orders for trade may be received from the counterparties. The orders are processed using a matching algorithm. The matching algorithm selects orders for a predefined entity. The matching algorithm then finds possible switch trades between the counterparties. For example, if “Counterparty A” wants to sell “Entity X” with maturity on “Date One” and then wants to buy the “Entity X” with maturity on “Date Two”, all counterparties that may buy “Entity X” with maturity on “Date One” and sell “Entity X” entity with maturity on “Date Two”. Different conditions may be applied to the orders for trade during the order processing, for example, minimum amount to match, maximum gap allowed between “Date One” and “Date Two”, counterparty willingness to trade, etc. The processed orders may be passed through an optimizer to obtain a trade set. The trade set optimizes different parameters, for example, number of trading counterparties, total number of trades, and total amount of risk reduced by the processing.

The trade set is displayed to the trading counterparty for approval with the other counterparty identity hidden. The counterparty is provided information regarding profit and loss for each trade based on the individual price and the consensus price for each trade. The counterparty is also provided information regarding net profit and loss across the trades, profit and loss across trades successfully executed, risk reduced if the trades are accepted, and the net risk reduced, as exemplarily illustrated in FIG. 3J.

The counterparties may store the trade information provided to a local computing device for further analysis. The counterparties may, for example, download the trade information into a spreadsheet processing program. The counterparties may modify the trade amount for each trade. The counterparties may then accept or reject each of the trades. Identities of the trading counterparties are revealed after the trade is approved and performed.

The performed trades may be provided in a trade blotter format to different banks for straight through processing, as exemplarily illustrated in FIG. 3K. Different reports are generated and presented during and after the trade, providing trade information, for example, amount of risk reduced, amount of possible risk reduction not performed, etc. The reports may be presented in tabular and graphical forms. A report presented in the tabular form is exemplarily illustrated in FIG. 3L.

Other than CDS, the trade risk management may be used in trade of interest rate derivatives, foreign exchange derivatives, equity derivatives, energy, environmental and catastrophe derivatives, and other financial instruments.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of managing financial risk involved in trading of a plurality of financial instruments between a plurality of counterparties, comprising the steps of:
determining a risk profile for each of said counterparties based on transaction data provided by the counterparties, wherein said transaction data relates to said trading of said financial instruments;
providing individual prices for a plurality of predefined maturity periods of the financial instruments by the counterparties based on said risk profile;
creating a consensus price for each of said predefined maturity periods based on said individual prices;
comparing said created consensus price with each of the individual prices provided by each of the counterparties;
computing said financial risk for each of the counterparties based on a plurality of predefined parameters and said comparison; and
modifying said computed financial risk of each of the counterparties for said management of the financial risk;
whereby the financial risk involved in the trading of the financial instruments between the counterparties is managed.

2. The computer implemented method of claim 1, wherein one of the financial instruments is a credit default swap, wherein said credit default swap is a bilateral agreement between the counterparties to trade credit risk of at least one third counterparty.

3. The computer implemented method of claim 2, wherein the counterparties are one or more of sellers and buyers of the credit default swap.

4. The computer implemented method of claim 1, further comprising a step of generating trade reports for the counterparties, wherein said trade reports comprise details of the trading.

5. The computer implemented method of claim 1, further comprising a step of performing a trade between the counterparties.

6. The computer implemented method of claim 5, further comprising a step of receiving an order for said trade from the counterparties.

7. The computer implemented method of claim 1, further comprising a step of normalizing the transaction data provided by the counterparties to a predefined format.

8. The computer implemented method of claim 1, wherein said step of creating said consensus price is performed using curve pricing.

9. The computer implemented method of claim 1, wherein said predefined parameters for computing the financial risk are one or more of entity, maturity dates, minimum amount, and maximum distance between two switches in a switch trade.

10. The computer implemented method of claim 1, wherein said step of modifying the computed financial risk comprises one of increasing and decreasing the financial risk for a trade to be performed.

11. A computer implemented system for managing financial risk involved in trading of a plurality of financial instruments between a plurality of counterparties, comprising:
a risk profiling module for determining a risk profile for each of said counterparties based on transaction data provided by the counterparties, wherein said transaction data relates to said trading of said financial instruments;
an individual pricing module for providing individual prices for a plurality of predefined maturity periods of the financial instruments based on said risk profile;
a consensus pricing module for creating a consensus price for each of said predefined maturity periods based on said individual prices;
a price comparison module for comparing said created consensus price with each of the individual prices provided by each of the counterparties;
a risk computation module for computing said financial risk for each of the counterparties based on a plurality of predefined parameters and said comparison;
and
a risk modifier for modifying said computed financial risk of each of the counterparties for said management of the financial risk.

12. The computer implemented system of claim 11, further comprising a report generation module for generating trade reports for the counterparties, wherein said trade reports comprise details of the trading.

13. The computer implemented system of claim 11, further comprising a trading module for performing a trade between the counterparties.

14. The computer implemented system of claim 13, wherein said trading module receives an order for said trade.

15. The computer implemented system of claim 11, further comprising a data normalization module for normalizing the transaction data provided by the counterparties to a predefined format.

16. A computer program product comprising computer executable instructions embodied in a computer-readable medium, wherein said computer program product comprises:
a first computer parsable program code for determining a risk profile for each of a plurality of counterparties based on transaction data provided by said counterparties, wherein said transaction data relates to trading of financial instruments;
a second computer parsable program code for obtaining individual prices for a plurality of predefined maturity periods of said financial instruments based on said risk profile;
a third computer parsable program code for creating a consensus price for each of said predefined maturity periods based on said individual prices;
a fourth computer parsable program code for comparing said created consensus price with each of the individual prices provided by each of the counterparties;
a fifth computer parsable program code for computing said financial risk for each of the counterparties based on a plurality of predefined parameters and said comparison; and
a sixth computer parsable program code for modifying said computed financial risk of each of the counterparties for management of the financial risk.
